(19) United States
(12) Patent Application Publication
(10) Pub. No.: US 2013/0127230 A1
(43) Pub. Date: May 23, 2013

(54) Vehicle shoulder belt extension

(71) Applicant: Anthony Fini, Blasdell, NY (US)

(72) Inventor: Anthony Fini, Blasdell, NY (US)

(21) Appl. No.: 13/373,573

(22) Filed: Nov. 21, 2011

(51) Int. Cl. B60R 22/12

(52) U.S. Cl. 297/486

(57) ABSTRACT

A safety belt extension plate is made for lowering a vehicle shoulder belt so that the belt does not ride up against the drivers or passengers neck. By lowering the shoulder belt adjustment position, the position of the shoulder belt can be made to rest in the middle of the drivers or passengers shoulder rather than near or against the occupants neck making the belt more comfortable and safer.

### BACKGROUND OF THE INVENTION

Shoulder belt safety devices were added to lap seat belts in order to prevent head injury and to overall increase safety in motor vehicle crashes. However, many of the shoulder belts tend to ride up near the neck of individuals and in some cases touching the neck even at their lowest adjustment position possible. The problem is especially common with shorter people or those between about 5 and 6 feet tall. Discomfort and even injuries have occurred when a shoulder belt can't be adjusted so that it rests about in the middle of the shoulder of an occupant. In addition, pre-existing medical conditions, such as thyroid surgery, have made the ill fitting safey belts a real problem. World renowned auto manufactures have stated, “the shoulder belt should rest in the middle of the shoulder or serious injury can occur.”

### SUMMARY OF THE INVENTION

The present invention extends the adjustment range of a shoulder belt without serious disassembly or modification of a present vehicle shoulder belt assembly. An extension plate is mounted between the existing shoulder belt mounting bolt and shoulder belt sling bracket. This safely and effectively lowers the shoulder belt position and extends its adjustment capability so that the belt can be adjusted to rest about in the middle of the shoulder of the driver of a motor vehicle or even the passenger since the extension plate can be installed in either the right or left side of a vehicle. The adjustment range for smaller and shorter people wearing a safey belt is extended and the adjustment lowering range is increased. Since the original adjustment slide and assembly of the shoulder belt is retained the final position of the belt can be fine tuned to rest in the middle of an occupants shoulder.

### DRAWINGS

FIG. 1—Is a front pictorial view of the invention and shows how it is installed.

FIG. 2—Is a side view of the extension plate, bolts and nuts.

### REFERENCE CHARACTERS AND PARTS TO WHICH THEY REFER

1 Adjustment slide
2 Mounting bolt
3 Second nut
4 Extension plate
5 Additional bolt
6 Sling bracket nut
7 Sling bracket
8 Shoulder belt
9 Additional plate hole
10 Adjustment assembly

### DESCRIPTION OF THE INVENTION

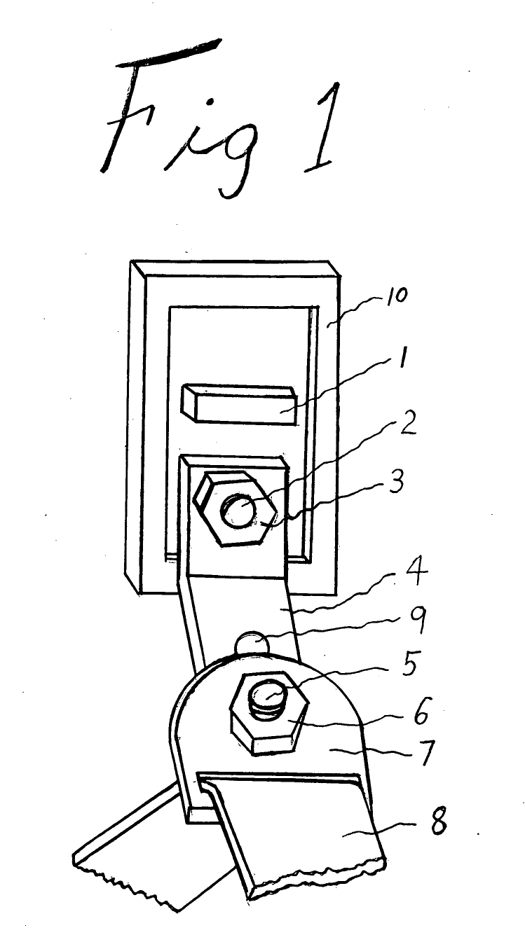

As shown in FIG. 1, an extension plate 4 made of ⅛ inch thick rectangular steel is mounted between the mounting bolt 2 of the adjustment assembly 10 and the shoulder belt sling bracket 7. Customarily the sling bracket 7 is mounted directly on the mounting bolt 2. An addional bolt 5 and a second nut 3 are needed for the retrofit and the original sling bracket nut 6 which is usually shouldered to allow the sling bracket 7 to still swivel can be reused. The second nut 3 rigidly secures the plate 4 to the mounting bolt 2. The shoulder belt 8 remains as is in the sling bracket 7. The adjustment slide 1 can still be used to fine tune the adjustment of the shoulder belt 8 final position. An additional plate hole 9 is an option and reduces the maximum extension. The center distance from the mounting bolt 2 and additional plate hole 9 is 1.5 inches and this was found sufficient for most people between about 5 and 6 feet tall. The further hole has a center distance of 2 inches.

Although the extension plate 4 is usually steel, the use of steel alloys or other materials could possibly be utilized in this invention.

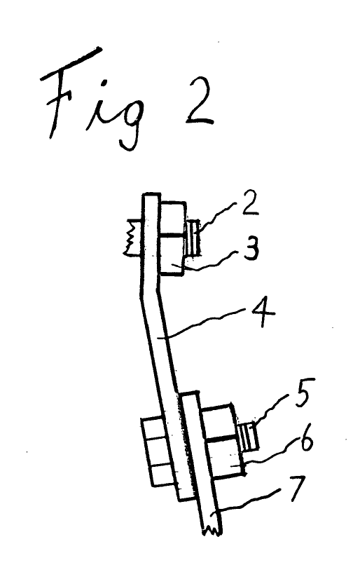

The extension plate 4 is shown in FIG. 2 as having a slight bend to it. This is to allow easy access to mount and tighten the additional bolt 5.

Although two holes for adjustment are shown for the extension plate, the option of having a slotted hole for more quicker adjustment is possible, but also has the disadvantage of possibly loosening in time. This is why the two separate adjustment holes are preferred.

Other modifications are possible within the scope of the appended claims.

I claim:

1. A shoulder safey belt extension means for extending a vehicle shoulder belt, mounting means for said extension means and said extension means is mounted between the adjustment assembly and the shoulder belt sling bracket of the vehicle wherby the adjustment range of a vehicle shoulder safety belt is extended.

2. The invention as specified in claim 1 wherein said extension means is a plate.

3. The invention as specified in claim 1 wherein said safety belt is adjusted so that it rests in the middle of the shoulder of an occupant.

4. A shoulder safety belt extension plate for lowering a vehicle shoulder belt, mounting means for said plate and said plate is mounted between the adjustment assembly and the shoulder belt sling bracket of the vehicle whereby the adjustment lowering range of a vehicle shoulder safey belt is increased.

5. The invention as specified in claim 4 wherein said mounting means consists of a plurality of holes in said plate and nuts and bolts for mounting said plate.

6. The invention of claim 5 wherein the holes are slotted.

7. The invention as specified in claim 4 wherein said plate is made of steel.

8. The invention as specified in claim 4 wherein said plate is made of alloy steel.

9. The invention as specified in claim 4 wherein said plate is made of other materials.

10. The invention as specified in claim 4 wherein said plate is rectangular in shape.

11. The invention as specified in claim 4 wherein said plate is ⅛ inch in thickness.

12. The invention as specified in claim 4 wherein said plate has a slight bend.

13. The invention as specified in claim 4 wherein the lowering range of the safety belt is increased 1.5 inches.

14. The invention as specified in claim 4 wherein the lowering range of the safety belt is increased 2 inches.

15. The invention as specifed in claim 4 wherein said safety belt is adjusted so that it rests in the middle of the shoulder of an occupant.
